(19) United States
(12) Patent Application Publication
(10) Pub. No.: US 2012/0001705 A1
(43) Pub. Date: Jan. 5, 2012

(54) High-Frequency Coupler

(76) Inventors: Daisuke Nozue, Kanagawa (JP); Takaki Naito, Kanagawa (JP); Daisuke Dobashi, Tokyo (JP); Shunnosuke Takasu, Kanagawa (JP)

(21) Appl. No.: 13/236,194

(22) Filed: Sep. 19, 2011

Related U.S. Application Data
(63) Continuation of application No. PCT/JP2010/054348, filed on Mar. 15, 2010.

(30) Foreign Application Priority Data
Mar. 19, 2009 (JP) 2009-068596

(51) Int. Cl. H01P 5/02

(52) U.S. Cl. 333/24 R

(57) ABSTRACT

A high-frequency coupler used in communication of high frequency signals, which aims to provide a high-frequency coupler satisfying both constant communication quality and thinning. The high-frequency coupler includes a circuit board and a toroidal coil. The circuit board includes a first receiving passageway and a second receiving passageway. The toroidal coil extends through the first receiving passageway and the second receiving passageway between a first surface and a second surface of the circuit board. The toroidal coil orbits on both sides of the first surface and the second surface in a circular shape. The toroidal coil reverses an orbiting direction at a position substantially near a half of a length of the toroidal coil.

### CROSS-REFERENCE TO RELATED APPLICATION

The application is a continuation of PCT International Application No. PCT/JP2010/054348 filed Mar. 15, 2010, which claims priority under 35 U.S.C. §119 to Japanese Patent Application No. 2009-068596, filed Mar. 19, 2009.

### FIELD OF THE INVENTION

The present invention relates to a high-frequency coupler used in communications of high frequency signals.

### BACKGROUND

In recent years, close proximity wireless transfer technology based on wideband radio technology has been developed and expected to become widespread in the future. The close proximity wireless transfer technology is a technology of performing non-contact communications using an antenna with an induction electric field. The close proximity wireless transfer technology is a technology that enables transfer of bulk data at a high speed in a short time, and is, for example, suitable for transfer of bulk data such as music and video data. Also, in the close proximity wireless transfer technology, a communication range is assumed to be within 3 cm, and has an advantage of a low possibility of data leakage at the time of communication.

As an antenna utilizing close proximity wireless transfer technology, a known high-frequency coupler has been developed, which includes a ground positioned on a back surface of a first circuit board, a resonance section (microstrip) positioned on a front surface of the first circuit board and connected to the ground by a receiving passageway passing through the first circuit board, and a coupling electrode positioned on a surface of a second circuit board laminated on a side of the front surface of the first circuit board, and connected to the resonance section by a receiving passageway passing through the second circuit board. In the high-frequency coupler, a longitudinal wave of an electric field oscillating in a direction parallel with a propagation direction is caused in a direction to the coupling electrode when viewed from the ground, and a high frequency signal is emitted to a communication counterpart by the longitudinal wave of the electric field (for example, see Japanese Patent Laid-Open No. 2008-271606).

In order to ensure constant communication quality with the high-frequency coupler disclosed in Japanese Patent Laid-Open No. 2008-271606, it is necessary to secure a predetermined distance between the ground and the coupling electrode separated by the first circuit board and the second circuit board and thus, it is difficult to minimize the known high-frequency coupler.

### SUMMARY

In view of the above circumstances, it is an object of the present invention to provide a high-frequency coupler satisfying both constant communication quality and thinning.

The high-frequency coupler includes a circuit board and a toroidal coil. The circuit board includes a first receiving passageway and a second receiving passageway. The toroidal coil extends through the first receiving passageway and the second receiving passageway between a first surface and a second surface of the circuit board. The toroidal coil orbits on both sides of the first surface and the second surface in a circular shape. The toroidal coil reverses an orbiting direction at a position substantially near a half of a length of the toroidal coil.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a top view of a high-frequency coupler according to the invention;

FIG. 2 is a bottom view of the high-frequency coupler shown in FIG. 1;

FIG. 3 is a perspective view of the high-frequency coupler shown in FIG. 1 and FIG. 2 when viewed from above and the front;

FIG. 4 is an enlarged perspective view of a part A shown in FIG. 3;

FIG. 5 is an enlarged perspective view of a part B shown in FIG. 4; and

FIG. 6 is an enlarged plane view of the part B shown in FIG. 4.

### DETAILED DESCRIPTION OF THE EMBODIMENT(S)

An embodiment of the present invention will be described below with reference to the drawings.

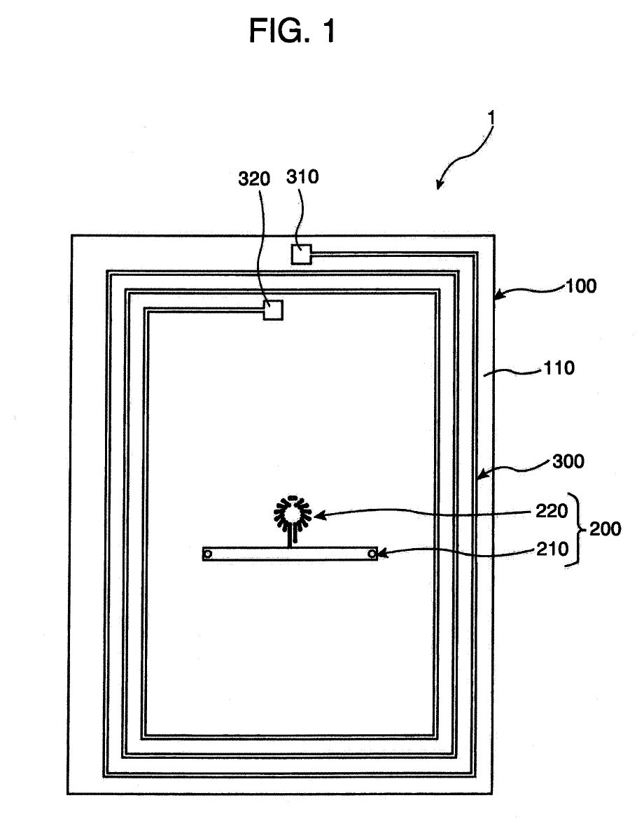

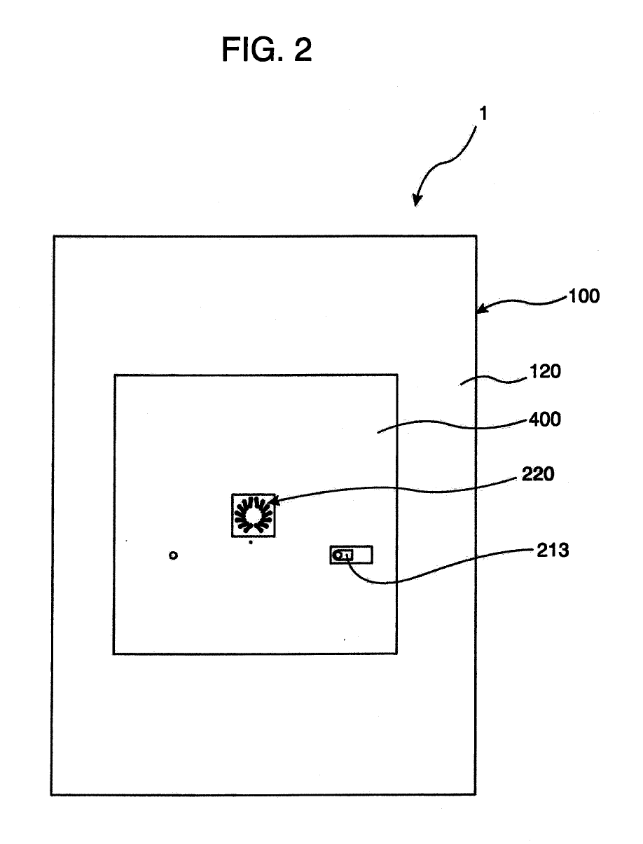

As shown in FIG. 1 to FIG. 3, a high-frequency coupler 1 according to the invention includes a circuit board 100, an electric field high-frequency coupler 200, and a loop antenna element 300. The electric field high-frequency coupler 200 has a microstrip 210 and a toroidal coil 220.

The circuit board 100 is made of an electrical insulating material.

The microstrip 210 of the electric field high-frequency coupler 200 is a member extending on a surface 110 of the circuit board 100, and has a length (for example, 18 mm to 19 mm) half the wave length of a high frequency signal used in communication using the electric field high-frequency coupler 200. One end 212 of the microstrip 210 is connected through a first receiving passageway 211 to a feed section 213 positioned on a back surface 120 of the circuit board 100. Further, one end of the toroidal coil 220 is connected to the microstrip 210 substantially at a middle point 214 of the microstrip 210. The one end of the toroidal coil 220 is equivalent to a starting end 221 of the toroidal coil 220.

Here, on the back surface 120 of the circuit board 100, in an area at least including the electric field high-frequency coupler 200, a flat conductor pattern 400 is formed. And, the other end 215 of the microstrip 210 with respect to the one end 212 is connected by a receiving passageway 211 to the flat conductor pattern 400 functioning as a ground.

The electric field high-frequency coupler 200 has the microstrip 210 and thus, it is possible to select a position of the microstrip 210 for connection to the starting end 221 of the toroidal coil 220, and the position may be made to serve as a position for efficiently supplying power to the toroidal coil 220. In the present embodiment, that position is set to be at the middle point 214 of the microstrip 210. In other words, that position is set to be a position apart from the one end 212 of the microstrip 210 connected to the feed section 213, by only a one-quarter length of the wave length of the high frequency signal used in the communication using the electric field high-frequency coupler 200. Therefore, a voltage in the middle point 214 of the microstrip 210 becomes a maximum, making it possible to efficiently supply the power to the toroidal coil 220 with the starting end 221 connected to the middle point 214.

The toroidal coil 220 of the electric field high-frequency coupler 200 is formed to straddle the surface 110 and the back surface 120 of the circuit board 100.

According to the high-frequency coupler 200 further having such a microstrip 210, a position of the microstrip 210 for connection to the one end of the toroidal coil 220 may be selected, and the position may be made to serve as a position to supply power to the toroidal coil 220 efficiently.

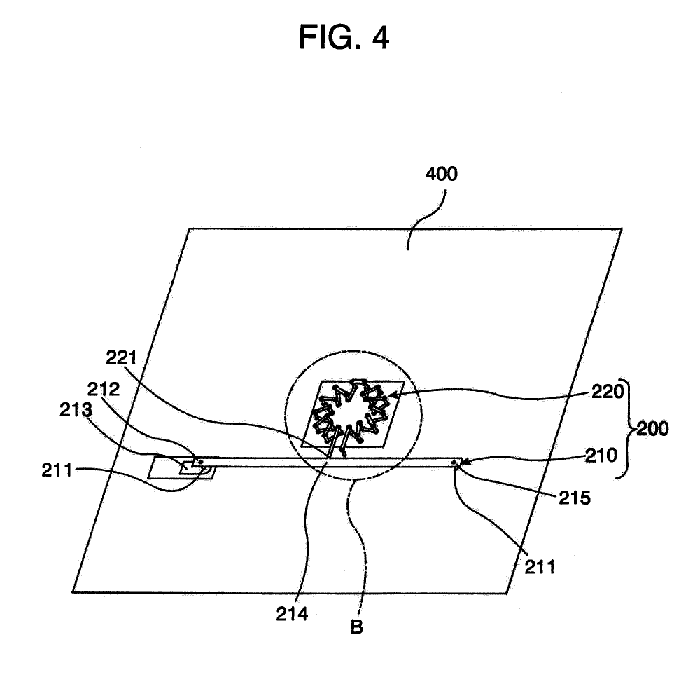

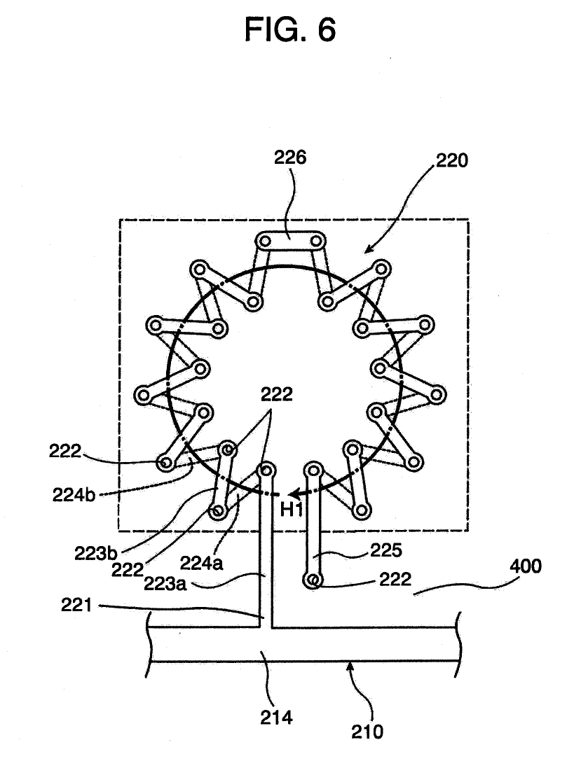

The toroidal coil 220 according to the invention will be specifically described with reference to FIG. 4 to FIG. 6. It is to be noted that in FIG. 6, a back-surface-side conductive pattern extending on the back surface 120 of the circuit board 100 is indicated by dashed lines.

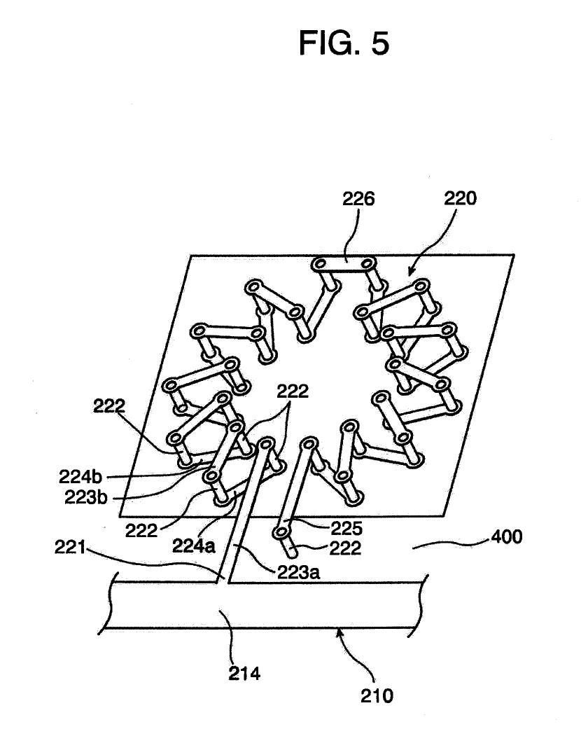

As shown in FIG. 5 and FIG. 6, in the toroidal coil 220, of a front surface-side conductive pattern 223a extending on the surface 110 of the circuit board 100, one end which is equivalent to the starting end 221 of the toroidal coil 220 is connected at the middle point 214 of the microstrip 210, and the other end with respect to the one end is connected to one end of a back-surface-side conductive pattern 224a extending to the back surface 120 through a second receiving passageway 222. And, in the toroidal coil 220, the other end with respect to the one end of the back-surface-side conductive pattern 224a extending on the back surface 120 of the circuit board 100 is connected to one end of another surface-side conductive pattern 223b extending on the surface 110 by a receiving passageway 222. Further, in the toroidal coil 220, the other end with respect to the one end of the surface-side conductive pattern 223b extending on the surface 110 of the circuit board 100 is connected to one end of yet another back-surface-side conductive pattern 224b extending on the back surface 120 through the second receiving passageway 222. By repeating such connection, the toroidal coil 220 forms substantially a circular pattern on the circuit board 100, while orbiting astride the surface 110 and the back surface 120. And then, a trailing end 225 of the toroidal coil 220 that has finished going around the circular pattern on the circuit board 100 is connected through the second receiving passageway 222 to the flat conductor pattern 400 functioning as the ground.

The toroidal coil 220 according to an exemplary embodiment of the invention has a length (for example, 18 mm to 19 mm) half the wave length of the high frequency signal used in the communication employing the electric field high-frequency coupler 200. Further, the toroidal coil 220 reverses an orbiting direction at a position 226 at half the overall length of the toroidal coil 220, on the way in going around on the circuit board 100.

According to such an electric field high-frequency coupler 200, a magnetic field is produced along the circle pattern formed by the toroidal coil 220 according to the invention.

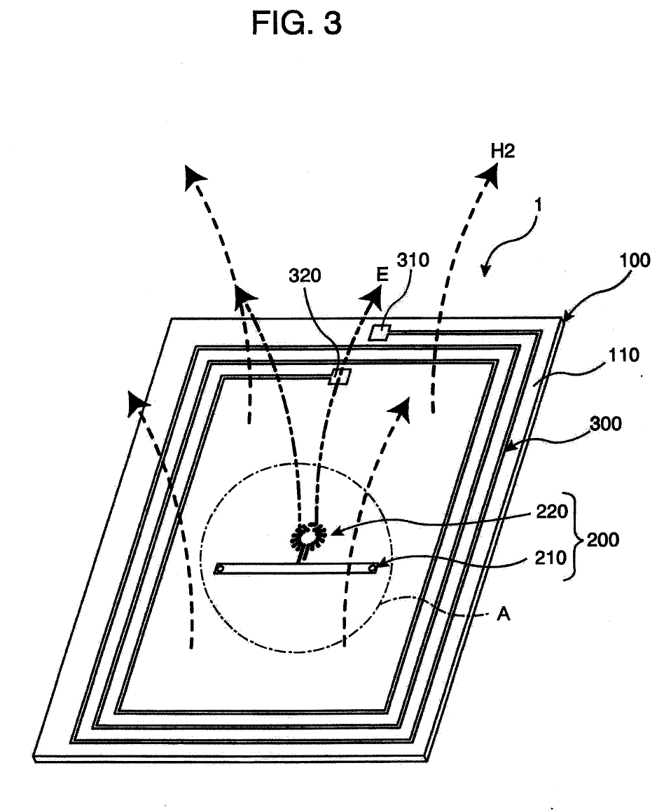

Further, the electric field high-frequency coupler 200 reverses the orbiting direction at the position 226 at half the overall length of the toroidal coil 220. In other words, the position at which the orbiting direction of the toroidal coil 220 is reversed is set to be a position apart from the starting end 221 or the trailing end 225 of the toroidal coil 220, only by one-quarter length of the wave length of the high frequency signal used in the communication employing the electric field high-frequency coupler 200. It is conceivable that when the overall length of a conductor forming the toroidal coil 220 has a length half the wave length of the high frequency signal, the polarity of distribution of the current in the conductor is reversed at the position 226 at half the overall length of the conductor which corresponds to the position apart from the trailing end 225 or the starting end 221 of the toroidal coil 220 only by the one-quarter length of the wave length of the high frequency signal, the position 226 serving as a boundary. Therefore, a current at the starting end 221 and the trailing end 225 of the toroidal coil 220 becomes a maximum, and the direction of a magnetic field generated by the toroidal coil 220 of the electric field high-frequency coupler 200 is aligned with, for example, an arrow-H1 direction shown in FIG. 6. And, an electric field in the direction orthogonal to the circuit board 100, as indicated by an arrow E shown in FIG. 3, is generated by the magnetic field indicated with the arrow H1. As a result, the electric field high-frequency coupler 200 emits the high frequency signal to a communication counterpart, by the electric field indicated with the arrow E.

Returning to FIG. 1 to FIG. 3, The loop antenna element 300 extends in parallel to the surfaces of the circuit board 100, and is formed to go around the electric field high-frequency coupler 200. A pair of element ends 310 and 320 of the loop antenna element 300 are feed sections. The loop antenna element 300 is used as a radio antenna of a so-called “RFID”, and a magnetic field in a direction orthogonal to the circuit board 100 as indicated by an arrow H2 illustrated in FIG. 3 is generated. As a result, the loop antenna element 300 emits a signal to a communication counterpart by the magnetic field indicated with the arrow H2.

The electric field high-frequency coupler 200 in the shown embodiment described above is configured with the circuit board 100, the microstrip 210, and the toroidal coil 220 and which facilitates minimizing the high-frequency coupler 1 which is smaller than the known high-frequency coupler, while ensuring constant communication quality. Further, in the high-frequency coupler 1 of the exemplary embodiment, both the electric field high-frequency coupler 200 and the loop antenna element 300 may be implemented using a substrate production technology that is conventionally known and thus, a contribution to a reduction in cost is also made.

Furthermore, the high-frequency coupler 1 of the shown embodiment has the electric field high-frequency coupler 200 inside the loop of the loop antenna element 300 and thus may simultaneously perform non-contact communications obtained by different technologies, such as sending and receiving of bulk data by the toroidal coil 220, and charging by the loop antenna element 300, for example.

It is to be noted that in the exemplary embodiment described above, the example in which the high-frequency coupler of the present invention has the microstrip connected to the one end of the toroidal coil has been described, but the high-frequency coupler of the present invention is not limited, and may be a high-frequency coupler having a circuit board and a toroidal coil without a microstrip.

Further, in the embodiment describe above, the example in which “the first surface and the second surface of the circuit board” according to the present invention are “the front surface and the back surface of the circuit board” has been described. However, “the first surface and the second surface of the circuit board” according to the present invention are not limited to the, and may be “the front surface and an internal-layer surface of the circuit board”, or may be “the internal-layer surface and the back surface of the circuit board”.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A high-frequency coupler comprising:
a circuit board having a first receiving passageway and a second receiving passageway; and
a toroidal coil extending through the first receiving passageway and the second receiving passageway between a first surface and a second surface of the circuit board while extending in a orbital pattern on both sides of the first surface and the second surface;
wherein an orbiting direction of the toroidal coil reverses at a position substantially near a half of a length of the toroidal coil.

2. The high-frequency coupler according to claim 1, wherein the length of the toroidal coil is half of a wave length of a signal passing through the coupler.

3. The high-frequency coupler according to claim 2, further comprising a microstrip extending along the circuit board and in parallel with the first and second surfaces, the microstrip connecting to one end of the toroidal coil.

4. The high-frequency coupler according to claim 1, further comprising a microstrip extending along the circuit board and in parallel with the first and second surfaces, the microstrip connecting to one end of the toroidal coil.

5. The high-frequency coupler according to claim 4, wherein the microstrip has a length being half of a wave length of a signal passing through the coupler.

6. The high-frequency coupler according to claim 5, wherein the one end of the toroidal coil connects to the microstrip at approximately a middle point of the microstrip.

7. The high-frequency coupler according to claim 4, wherein the one end of the toroidal coil connects to the microstrip at approximately a middle point of microstrip.

8. The high-frequency coupler according to claim 6, further comprising an antenna element extending in parallel with the first and second surfaces of the circuit board and along an orbital path about the toroidal coil.

9. The high-frequency coupler according to any of claim 1, further comprising an antenna element extending in parallel with the first and second surfaces of the circuit board and along an orbital path about the toroidal coil.
